(19) United States
(12) Patent Application Publication
(10) Pub. No.: US 2010/0110199 A1
(43) Pub. Date: May 6, 2010

(54) Measuring Video Quality Using Partial Decoding

(76) Inventors: Stefan Winkler, Santa Clara, CA (US); Praveen Mohandas, Thousand Oaks, CA (US); Yves Cognet, Menlo Park, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/264,175

(22) Filed: Nov. 3, 2008

(51) Int. Cl. H04N 17/00

(52) U.S. Cl. 348/180; 348/E17.001

(57) ABSTRACT

The quality of video that is broadcast as a packet-based video stream is measured using decoded pictures in combination with information extracted from the transport stream and elementary stream layers of the packet-based video stream. The decoded pictures include selected frames and/or slices decoded from the packet-based video stream and are used to generate video content metrics. A composite score for the video quality can be generated from the video content metrics in combination with quality metrics of the transport stream and/or the elementary stream. If the composite score falls below a minimum score, a snapshot of the video is captured for later analysis.

### BACKGROUND OF THE INVENTION

1. Field of the Invention

Embodiments of the present invention relate generally to packet-based video systems and, more particularly, to a method and a system for measuring the video quality of a packet-based video stream.

2. Description of the Related Art

Packet-based video systems have seen continued increase in use through streaming, on demand, Internet protocol television (IPTV), and direct broadcast satellite (DBS) applications. Typically, in packet-based video systems, one or more video programs are encoded in parallel, and the encoded data are multiplexed onto a single channel. For example, in IPTV applications, a video encoder, a commonly used device or software application for digital video compression, reduces each video program to a bitstream, also referred to as an elementary stream (ES). The ES is then packetized for transmission to one or more end users. Typically, the packetized elementary stream, or PES, is encapsulated in a transport stream or other container format designed for multiplexing and synchronizing the output of multiple PESs containing related video, audio, and data bitstreams. One or more transport streams are further encapsulated into a single stream of IP packets, and this stream is carried on a single IP channel.

FIG. 1 is a schematic block diagram of a digital video program 100 separated into its constituent elements and organized in transport layers. Transport stream 110 is the highest layer and encapsulates PES1, PES2, and PES3, which make up the digital video program, and is used to identify and interleave the different data types contained therein. Transport stream 110 supports multiple audio and video streams, subtitles, chapter information, and metadata, along with synchronization information needed to play back the various streams together. Numerous multimedia container formats are known in the art, including MP4, AVI, RealMedia, RTP and MPEG-TS. For digital broadcasting, RTP and MPEG-TS are standard container formats.

As shown, transport stream 110 contains a video bitstream ES1, an audio bitstream ES2, and a data bitstream ES3. Video bitstream ES1 is an elementary stream that includes compressed video content of digital video program 100 and is packetized as PES1. The video content in video bitstream ES1 is typically organized into additional layers (not shown), such as a slice layer, a macroblock layer, and an encoding block layer. Audio bitstream ES2 is an elementary stream that includes compressed audio content of digital video program 100 and is packetized as PES2. Data bitstream ES3 is an elementary stream that includes additional data associated with digital video program 100, such as subtitles, chapter information, an electronic program guide, and/or closed captioning. Data bitstream ES3 is packetized as PES3. Other information, such as metadata and synchronization information for recombining PES1, PES2, and PES3, is also contained in transport stream 110. In FIG. 1, transport stream 110 is illustrated as encapsulating a single digital video program, i.e., digital video program 100. However, transport streams typically include multiple video and audio streams, as in the case of MPEG-TS.

Video quality is known to be of high importance to end users. However, digital video, and particularly packet-based video, is subject to multiple sources of video distortions that can affect video quality as perceived by the end user. Digital video pre- and post-processing, compression, and transmission are all such sources. Digital video pre- and post-processing includes conversions between different video formats and resolutions, filtering, de-interlacing, etc. Digital video processing artifacts can result in temporal video impairments, jerkiness, color distortions, blur, and loss of detail.

Compression of video content into a video bitstream usually involves quantization. Quantization is a lossy compression technique achieved by limiting the precision of symbol values. For example, reducing the number of colors chosen to represent a digital image reduces the file size of the image. Due to the inherent loss of information, quantization is a significant source of visible artifacts. Another source of compression-related video distortions is inaccurate prediction. Many encoders employ predictive algorithms for more efficient encoding, but due to performance constraints, such algorithms can lead to visible artifacts, including blockiness, blur, color bleeding, and noise.

Transmission of packet-based video involves the delivery of a stream of packets, such as IP packets, over a network infrastructure from a content provider to one or multiple end users. Network congestion, variation in network delay between the content provider and the end user, and other transmission problems can lead to a variety of video impairments when the packet stream is decoded at the end user. Packet loss, bit errors, and other issues manifest themselves in the video with varying severity, depending on which part of the bitstream is affected. For example, in motion-predictive coding, predicted frames and slices in the video rely on other parts of the video as a reference, so the loss of certain packets can lead to significant error propagation, and thus, the same packet loss rate can yield a substantially different picture quality at different times.

To improve the quality of packet-based video delivered to the end user, video quality throughout the network infrastructure is continuously monitored. Such monitoring enables robust troubleshooting of the network, so that video quality issues can be found and corrected. Also, monitoring of video quality throughout the network highlights where to best direct resources for improving the quality of video delivered to the end user. However, raw network metrics and other easily quantified metrics, e.g., packet loss rate or bit error rate, do not provide an accurate assessment of video quality as perceived by the end user. In addition, video impairments are produced by a wide range of sources, some of which are not directly caused by the network, such as video pre-/post-processing and compression. Thus, more sophisticated video quality metric schemes are used in the art.

Currently, video quality metrics can be provided using either transport stream/elementary stream metrics or decoded video metrics. Transport stream (TS) and elementary stream (ES) metrics analyze information contained in the transport stream packet headers and the encoded bitstream, respectively. For example, information related to the encoded video content contained in bitstream ES1 in FIG. 1 can be accessed directly from transport stream 110 and PES1, without decoding the video content. Due to the relatively small amount of data used as input for TS and ES metrics, they are computationally efficient and therefore highly scalable, but cannot accurately measure many video impairments. In contrast, decoded video metrics analyze video content directly from frames decoded from a video bitstream, such as video bitstream ES1, in FIG. 1. This approach allows more accurate measurement of video impairments, but is computationally expensive. In addition, important information related to video quality can be contained in the TS and ES, and this information is not accessed when using decoded video metrics alone.

### SUMMARY OF THE INVENTION

One or more embodiments of the invention provide a method and system for measuring the quality of video that is broadcast as a packet-based video stream. Video quality is measured using decoded pictures in combination with information extracted from the TS and video ES. The decoded pictures include selected frames and/or slices decoded from the video ES and are used to calculate video content metrics. Furthermore, an estimate of mean opinion score (MOS) for the video is generated from the video content metrics in combination with TS and/or ES metrics.

A method of measuring video quality according to a first embodiment includes the step of receiving a TS, parsing the TS to extract an ES containing video packets, extracting information from the TS and the ES, calculating video content metrics representative of the video quality from the ES, and generating a composite video quality score based on the video content metrics and one or both of the TS information and the ES information.

A method of measuring video quality according to a second embodiment includes the steps of receiving a video stream, partially decoding the video stream, calculating video content metrics representative of the video quality from the partially decoded video stream, and generating a composite video quality score based on the video content metrics.

An additional embodiment of the invention includes a method for capturing and storing a video snapshot at or around the time instant where video issues are detected by the TS, ES or video content metrics. This video snapshot can be in the form of a thumbnail image, a few video frames, or a short part of the video.

A packet-based video distribution system according to an embodiment of the invention includes a video encoder for encoding a video stream, a video decoder for decoding the video stream, a plurality of video delivery nodes between the video encoder and the video decoder, a plurality of probes positioned between the video encoder, the different video delivery nodes, and the video decoder. Each of the probes includes a partial decoder for partially decoding the video stream and is configured to measure video quality based on the partially decoded video stream.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic block diagram of a digital video program separated into its constituent elements and organized in processing layers.

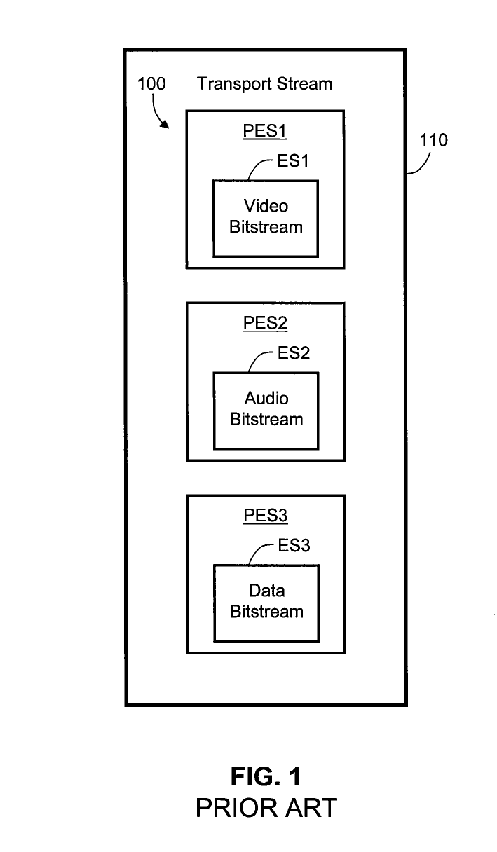

FIG. 2 is a block diagram illustrating a method for analyzing quality of packet-based video, according to an embodiment of the invention.

FIG. 3 is a block diagram of a quality measurement setup, which is implemented at multiple points in a network infrastructure, according to embodiments of the invention.

For clarity, identical reference numbers have been used, where applicable, to designate identical elements that are common between figures. It is contemplated that features of one embodiment may be incorporated in other embodiments without further recitation.

### DETAILED DESCRIPTION

Embodiments of the invention contemplate a method of quantifying the quality of video contained in a packet-based video program using decoded pictures in combination with information extracted from the transport stream (TS) and/or elementary stream (ES) layers of the video bitstream. Information from the TS layer and the ES layer is derived from inspection of packets contained in the video stream. Each ES of interest is parsed from the TS, and each ES is itself parsed to extract information related to the video content, such as codec, bitrate, etc. The decoded pictures may include selected frames and/or slices decoded from the video ES, and are analyzed by one or more video content metrics known in the art. An estimate of mean opinion score (MOS) for the video is then generated from the video content metrics in combination with TS and/or ES quality metrics.

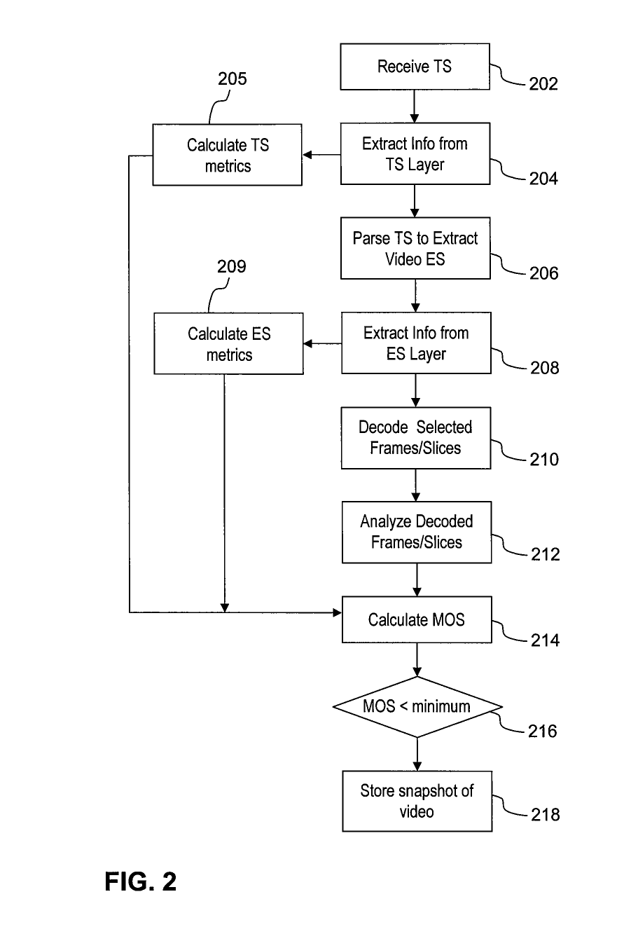

FIG. 2 is a block diagram illustrating a method 200 for analyzing quality of packet-based video, according to an embodiment of the invention. In step 202, a transport stream containing a packet-based video stream is received. It is contemplated that step 202 can be performed at various points throughout a network infrastructure where an encoded and packetized bitstream or transport stream is available.

In step 204, TS layer information is extracted from the TS layer of the packet-based video stream. TS layer information includes the Program Clock Reference (PCR), which is used for synchronizing the decoder clock and timing the playback of the video. In addition, TS layer information 221 may include information for selecting the requisite packetized elementary stream from the transport stream for partial decoding, which is described below in step 210. In this way, portions of the transport stream that do not require quality analysis can be ignored, such as metadata, closed captioning, or video programs that are not being analyzed. In step 205, TS metrics are calculated from the TS layer information. TS metrics include PCR jitter, PCR accuracy, and metrics related to TS packet loss, which may be used to quantify certain aspects of video quality. For example, PCR jitter and PCR accuracy measure the variation and precision of the program clock reference. Packet loss measurements are derived from the arrival of the individual TS packets.

In step 206, the transport stream is parsed to extract the video ES of interest. ES layer information is then extracted from the video ES in step 208. ES layer information includes information related to codec, bitrate, frame types, slice types, block types, block boundaries, motion vectors, presentation time stamps, etc. In step 209, ES metrics are calculated from the ES layer information. ES metrics include slice/frame type lost, I-frame/slice ratio, and picture losses, all of which may be used to quantify certain aspects of video quality. For example, the type of slice or frame lost indicates the severity of the resulting visual impairment of a loss; the I-frame/slice ratio indicates the complexity of the video; and picture losses estimate the amount of video picture affected by packet losses.

In step 210, partial decoding of the video ES is performed on selected frames and/or slices. Decoding of the selected frames and/or slices, as well as selection thereof, is based on the TS layer information and/or the ES layer information. In one embodiment, partial decoding includes decoding one or more sets of I-slices contained in the video sequence. In the H.264 video compression standard, such I-slices are coded without reference to any other slices except themselves and contain only intra-coded macroblocks. Decoding only I-slices for subsequent quality analysis is computationally much less expensive compared to decoding the complete frames or video sequence for two reasons. First, only a portion of the video is actually decoded, and second, the portions selected for decoding, i.e., the I-slices, can be decoded relatively quickly.

In another embodiment of partial decoding, frames containing only intra-coded macroblocks, i.e., frames that do not depend on data from the preceding or the following frames, are decoded for subsequent quality analysis. In the MPEG-2 video compression standard, such frames are referred to as I-frames. Decoding only I-frames for subsequent quality analysis is computationally efficient for the same reasons described above for decoding only I-slices.

In still another embodiment of partial decoding, a combination of frame types is selected for decoding. For instance, the MPEG-2 video compression standard specifies three types of frames: intra-coded frames (I-frames), predictive-coded frames (P-frames), and bidirectionally-predictive-coded frames (B-frames). P-frames reference a previous picture in the decoding order, thus requiring the prior decoding of that frame in order to be decoded. B-frames reference two or more previous pictures in the decoding order, and require the prior decoding of these frames in order to be decoded. P-frames and B-frames may contain image data, motion vector displacements, and combinations of both. It is contemplated that a combination of different frame types and/or slice types may be selected for decoding as part of the partial decoding of step 207, and not simply frames or slices containing only intra-coded macroblocks, such as I-frames and I-slices. For example, if the decoded video metrics used in subsequent quality analysis are related to motion, selective decoding of some or all B- and/or P-frames or slices may be performed in the partial decoding process of step 210, in addition to the selective decoding of I-frames or slices.

In step 210, the partially decoded video is analyzed to calculate video content metrics. Video content metrics are quantified measurements of video impairments and are produced by means of algorithms known in the art and/or readily devised by one of skill in the art. Such algorithms generally require decoded video content, such as decoded frames and/or slices to produce meaningful output.

There are a number of video content metrics that may be used to quantify the quality of decoded video content, including “blackout,” “blockiness,” “video freeze,” and “jerkiness.” Blackout refers to a video outage, indicated by a single-color frame that persists for a specified time period. Such a blackout may be detected by analyzing the luminance or color of decoded frames. Blockiness refers to the visibility of block artifacts along block boundaries. Video freeze occurs when a picture is not updated, and can be detected by checking for changes in the picture between consecutive decoded frames. Jerkiness is an indicator of motion smoothness and related artifacts, and may be based on the analysis of motion in a video. “Blur” and “noise” are additional video content metrics that may be used to quantify the quality of decoded video content.

In one embodiment, ES layer information is used in calculating the video content metrics. The inclusion of ES layer information improves the accuracy and computational efficiency of the process used to generate video content metrics. ES layer information may include codec type, frame type, slice type, block type, block size and block boundary information, quantizer value, motion vectors, etc. As an example, motion vectors from the ES layer contain valuable motion information about the video, which can help improve the accuracy of video content metrics in an efficient manner. Likewise, information about the block sizes and block boundaries can make the measurement of blockiness impairments much more efficient and accurate.

Codec information can indicate what artifacts are most likely to occur, how they affect video quality, and how and where they may be found in the video. For example, knowledge that a video was encoded using MPEG-2 rather than H.264 indicates that block boundaries lie on a regular 16×16 macroblock grid, simplifying blockiness calculations. Knowing the bitrate used for video encoding, together with information about the video codec, resolution, and frame rate, is helpful in estimating a baseline for the overall video quality, and a reliable baseline improves the accuracy of video quality measurements. An accurate estimate of image complexity helps determine the visibility of video impairments, and can be derived from the ES layer information, such as bitrate and the distribution of coding coefficients from the bitstream. Information regarding frame/slice/block types, e.g., I-, P-, or B-frames or slices, assists in estimating image complexity, detecting scene cuts, and otherwise making the video content metrics more accurate. Motion information is another important parameter for quality measurement, since motion affects the visibility of impairments and is an indicator of the coding complexity of a video. Estimating motion in a video from decoded frames is computationally intensive, but the motion vectors included in ES layer information obviate the need for performing such calculations in step 212. Thus, the use of ES layer information in step 212 provides more accurate and more easily generated output, i.e., video content metrics, when applied to the decoded frames and slices from step 210.

In step 214, an estimate of mean opinion score (MOS) is calculated for the packet-based video. The algorithm for generating video MOS incorporates video content metrics in combination with TS metrics and/or ES metrics. Depending on a number of factors, such as sampling location, sampling application (e.g., monitoring, alarm generation, or acceptance testing), etc., the relative weighting of each input to step 214 may be varied. One of skill in the art can devise an appropriate weighting scheme between the output of video content metrics and TS/ES layer metrics to accommodate a given video quality test scenario. In one embodiment, vision modeling, which deals with the complexity of user perception, may be incorporated into the weighting scheme of the MOS algorithm. In this way, video impairments can be scaled according to human vision metrics to better reflect the visual perception of the end user.

The use of a MOS to quantify video quality based on decoded video content in conjunction with ES layer and/or TS layer information provides a number of advantages over methods known in the art. First, a higher level of accuracy can be achieved compared to using only one or the other type of information. Second, by extracting information from the ES layer, the video quality MOS can be generated with high computational efficiency, thereby making this process scalable. Third, while based on quantifiable video content metrics, each component making up the MOS can also be weighted according to perceptual criteria, for example, to better reflect the impact of video impairments as experienced by the end user.

For later analysis of the data and video impairments, it is useful to capture snapshots of the video at or around the time instant where video issues are detected by the TS, ES or video content metrics, e.g., when the video quality MOS falls below a predefined minimum. Since the video has been partially decoded, at least a subset of the frames will be available for these snapshots. The video snapshot can be in the form of a thumbnail image of the affected frame, a few video frames, or a short part of the video, depending on the capture capabilities and storage space available. The snapshots can be stored in a database together with the video quality measurements for later analysis and checks. The video snapshot can be scaled down to a lower resolution and/or re-encoded to alleviate storage constraints. In step 216, the video quality MOS is compared against a minimum score determined by the system operator. If the video quality MOS is below the minimum score, then, in step 218, a snapshot of the video is captured as described above.

Method 200 is described in terms of measuring the quality of a single packet-based video program. In another embodiment, method 200 in FIG. 2 is used to quantify multiple video elementary streams or programs contained in a single transport stream.

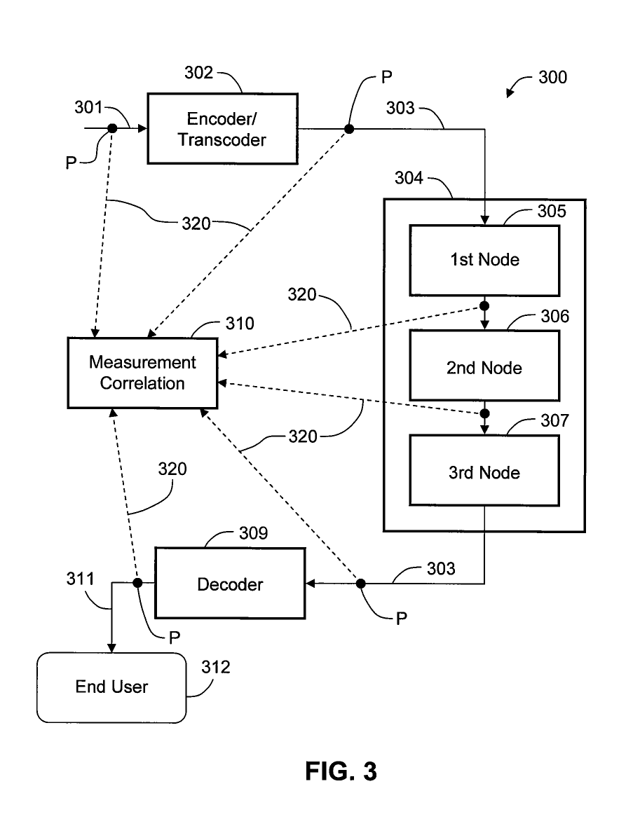

Since method 200 in FIG. 2 has high computational efficiency, it may be used to report a MOS at regular time intervals to monitor temporal variations of quality and for triggering alarms as a function of such variations. In addition, method 200 may be implemented throughout a network infrastructure from a content provider to one or multiple end users. FIG. 3 is a block diagram of a quality measurement setup 300, in which method 200 is implemented at multiple points in a network infrastructure, according to embodiments of the invention.

Quality measurement setup 300 includes a delivery network 304, such as an IP network, an encoder/transcoder 302 positioned “upstream” of delivery network 304, a decoder 309 positioned “downstream” of delivery network 304, and a measurement correlation unit 310, which is coupled to the delivery path of a packet-based video to an end user 312 by probes P. The delivery path of packet-based video begins with source video 301 and passes through encoder/transcoder 302 to delivery network 304 as an encoded bitstream 303. The delivery path is routed through a plurality of nodes in delivery network 304 (a first node 305, a second node 306, and a third node 307 are shown) to decoder 309 for delivery to the end user as a decoded video 311. Probes P are positioned to assess video quality at a variety of points along the delivery path, and transmit quality measurement 320 to measurement correlation unit 310. In this way, method 200 may be used to quantify the quality of a packet-based video program at the end user, before and after encoding, before and after decoding, and throughout the IP delivery network.

Each of the elements shown in FIG. 3 is implemented as a computer system including a processing unit that is programmed to carry out the functions described therein.

While the foregoing is directed to embodiments of the present invention, other and further embodiments of the invention may be devised without departing from the basic scope thereof, and the scope thereof is determined by the claims that follow.

What is claimed is:

1. A method of measuring video quality, comprising the steps of:
receiving a transport stream (TS);
parsing the TS to extract an elementary stream (ES) containing video packets;
extracting information from the TS and the ES;
partially decoding the ES;
generating video content metrics representative of the quality from the partially decoded video; and
generating a composite video quality score based on the video content metrics, and one or both of the TS information and the ES information.

2. The method according to claim 1, wherein the ES information includes at least one of codec, bitrate, frame/slice/block types, block boundaries, and motion vectors.

3. The method according to claim 1, further comprising the step of generating TS quality metrics from the TS information, wherein the composite video quality score is generated from the video content metrics and the TS quality metrics.

4. The method according to claim 1, further comprising the step of generating ES quality metrics from the ES information, wherein the composite video quality score is generated from the video content metrics and the ES quality metrics.

5. The method according to claim 1, further comprising the steps of generating TS quality metrics from the TS information and generating ES quality metrics from the ES information, wherein the composite video quality score is generated from the video content metrics, the TS quality metrics, and the ES quality metrics.

6. The method according to claim 1, further comprising the step of decoding the ES, wherein the video content metrics are generated from the decoded ES.

7. The method according to claim 6, wherein the ES is only partially decoded and the video content metrics are generated from the partially decoded ES.

8. The method according to claim 7, further comprising:
if any of the computed metrics exceeds a predefined threshold or the composite video quality score falls below a predefined threshold, storing a video snapshot generated from the partially decoded ES.

9. The method according to claim 8, wherein the video snapshot comprises one of a thumbnail image, a few video frames, or a short part of the partially decoded ES.

10. A method of measuring video quality, comprising the steps of:
receiving a video stream;
partially decoding the video stream; and
generating video content metrics representative of the video quality from the partially decoded video stream.

11. The method according to claim 10, wherein the video content metrics include at least one of blackout, jerkiness, blockiness, blur, and video freeze.

12. The method according to claim 10, wherein the video stream comprises a packet-based video stream.

13. The method according to claim 12, wherein the step of partially decoding includes decoding only I-slices of the packet-based video stream.

14. The method according to claim 12, wherein the packet-based video stream includes compressed frames of multiple types and the step of partially decoding includes decoding only a subset of the multiple types of frames contained in the packet-based video stream.

15. The method according claim 10, further comprising:
if the video quality is determined to be poor, storing a video snapshot generated from the partially decoded video stream.

16. The method according to claim 15, wherein the video snapshot comprises one of a thumbnail image, a few video frames, or a short part of the partially decoded video stream.

17. A video distribution system, comprising:
a video encoder for encoding a video stream;
a video decoder for decoding the video stream;
a plurality of video delivery nodes between the video encoder and the video decoder;
a first probe positioned between the video encoder and a first of the video delivery nodes; and
a second probe positioned between the last of the video delivery nodes and the video decoder,
wherein each of the first and second probes includes a partial decoder for partially decoding the video stream and is configured to measure video quality based on the partially decoded video stream.

18. The system according to claim 17, further comprising additional probes in between the plurality of video delivery nodes, wherein each additional probe includes a partial decoder for partially decoding the video stream and is configured to measure video quality based on the partially decoded video stream.

19. The system according to claim 17, further comprising a measurement correlation unit for collecting video quality measurements from all of the probes.

20. The system according to claim 17, wherein each of the probes extracts transport layer information and elementary stream layer information from the video stream and measures video quality based on the partially decoded video stream, the transport layer information, and the elementary stream layer information.
